(19) United States
(12) Patent Application Publication
(10) Pub. No.: US 2017/0345060 A1
(43) Pub. Date: Nov. 30, 2017

(54) SYSTEMS AND METHODS FOR CENTRALIZED COORDINATED MESSAGING AMONG PARTICIPANT NODES IN A PHARMACEUTICAL NETWORK

(71) Applicant: Truveris, Inc., New York, NY (US)

(72) Inventors: Bertrand Janin, West Orange, NJ (US); Anthony Loiacono, Bayonne, NJ (US)

(73) Assignee: Truveris, Inc., New York, NY (US)

(21) Appl. No.: 15/610,480

(22) Filed: May 31, 2017

Related U.S. Application Data
(60) Provisional application No. 62/343,312, filed on May 31, 2016.

(51) Int. Cl. G06Q 30/02; H04L 12/58; G06F 19/00

(52) U.S. Cl. CPC G06Q 30/0269; H04L 51/046; G06Q 30/0267; G06F 19/3456; G06Q 30/0239; G06Q 30/0277

(57) ABSTRACT

Obtaining, by a central system, a plurality of first data messages over a network from a plurality of first remote systems; generating first information based on the first data messages; receiving a second data message including second information from a second remote system; comparing the second information with at least a portion of the first information; determining whether a patient associated with the second information is eligible for a promotion based on the comparing; if eligible, generating a third data message authorizing the second remote system to provide a discount based on the first information; and providing the third data message to the second remote system; if ineligible, generating a fourth data message, the fourth data message indicating the patient is not eligible to receive a discount; and providing the fourth data message to the second remote system.

### CROSS-REFERENCE TO RELATED APPLICATIONS

The present application claims the benefit of U.S. Provisional Patent Application Ser. No. 62/343,312, filed May 31, 2016 and entitled “Universal Coupon Program,” which is hereby incorporated by reference herein.

### TECHNICAL FIELD

This disclosure pertains to systems for centralized coordinated network messaging. More specifically, this disclosure relates to systems for centralized coordinated messaging among participant nodes in a pharmaceutical network.

### BACKGROUND

In general, patients can fulfill medical prescriptions at retail pharmacies. For example, a patient can obtain a prescription for a particular medication from his or her physician, and submit that prescription to a pharmacy for fulfillment. The pharmacy can validate the prescription with the physician and dispense the medication to the patient.

In many cases, prescription costs may be subsidized or discounted through various pharmaceutical promotions. Under convention approaches, users (e.g., pharmacy technicians) manually enter pharmaceutical promotion information for each prescription, which can result in users manually entering information for tens or thousands of discreet promotions on a daily basis. The pharmaceutical promotions, which can number over seven hundred different active programs in the U.S. alone, typically require users to enter lengthy numerical sequences that cause unnecessary stress on communications networks, customer delays, and/or wasted time troubleshooting pharmaceutical programs (e.g., caused by data entry errors).

### SUMMARY

A claimed solution rooted in computer technology overcomes problems specifically arising in the realm of computer technology. In various embodiments, a centralized coordinated messaging system is provided for obtaining promotion information from pharmaceutical manufacturer systems, obtaining pharmacy transaction information from pharmacy systems, and automatically processing pharmaceutical promotions for pharmacy transactions (e.g., without requiring user input).

Various embodiments of the present disclosure include systems, methods, and non-transitory computer readable media configured to obtain, by a central participant node computing system, a plurality of first data messages, each of the plurality of first data messages including promotion information, the plurality of first data messages being received over a communication network from a plurality of first remote participant node computing systems. The central participant node computing system stores the promotion information of the plurality of first data messages in a datastore of the central participant node computing system. The central participant node computing system receives a second data message including pharmacy transaction information, the pharmacy transaction information including patient information and prescription information associated with a particular pharmacy transaction, the second data message being received over the communication network from a second remote participant node computing system. The central participant node computing system compares the pharmacy transaction information with at least a portion of the one or more promotions. The central participant node computing system determines whether a patient associated with the pharmacy transaction information is eligible for at least one of the one or more promotions based on the comparing. If the patient associated with the pharmacy transaction information is eligible for at least one of the one or more promotions, the central participant node computing system generates a third data message, the third data message authorizing the second remote participant node computing system to provide the patient a discount based on the at least one of the one or more promotions; and provides the third data message to the second remote participant node computing system over the communication network. If the patient associated with the pharmacy transaction information is not eligible for at least one of the one or more promotions, the central participant node computing system generates a fourth data message, the fourth data message indicating the patient is not eligible to receive the discount associated with the promotion; and provides the fourth data message to the second remote participant node computing system over the communication network.

In some embodiments, the promotion information includes any of corresponding manufacturer identification information associated with each of the corresponding pharmaceutical promotions, type of promotion associated with each of the corresponding pharmaceutical promotions, or a promotion value associated with each of the corresponding pharmaceutical promotions.

In some embodiments, the first remote participant node computing system comprises a pharmaceutical manufacturing system remote from the central participant node computing system.

In some embodiments, the patient information includes any of a member identifier identifying the patient, or insurance information associated with the patient, and the prescription information includes a pharmaceutical identifier and pharmaceutical dosage amount.

In some embodiments, the pharmacy transaction information includes manufacturer information associated with a particular promotion, and the comparing and the determining utilize the manufacturer information of the pharmacy transaction information to perform the comparing and the determining. In related embodiments, the manufacturer information of the pharmacy transaction comprises pre-defined manufacturer information obtained from a second datastore of the second remote participant node computing system.

In some embodiments, the pharmacy transaction information does not include manufacturer information, and the comparing and the determining utilize manufacturer information stored by the central participant node computing system to perform the comparing and the determining, thereby reducing a performance load of the communication network.

In some embodiments, the instructions further cause the system to perform determining, by the central participant node computing system, the discount in response to a determination the patient is eligible for the one or more promotions.

In some embodiments, the discount is determined by a payer system in remote communication with the central participant node computing system over the communication network.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 depicts a diagram of an example system for centralized coordinated messaging among participant nodes of a pharmaceutical network.

FIG. 2 depicts a diagram of an example centralized coordinated messaging system according to some embodiments.

FIG. 3 depicts a flowchart of an example method of centrally coordinating messages among participant nodes of a pharmaceutical network according to some embodiments.

FIG. 4 depicts a flowchart of an example method of reducing network performance load based on central coordination of messages among participant nodes of a pharmaceutical network according to some embodiments.

FIG. 5 depicts a flowchart of an example method of centrally coordinating messages among participant nodes of a pharmaceutical network according to some embodiments.

FIG. 6 is a diagram of an example computer system for implementing the features disclosed herein.

### DETAILED DESCRIPTION

Typically, when a patient purchases prescription pharmaceuticals (or, “medications”), the cost of the medication may be partially or fully covered through an insurance policy provided by the patient's insurance carrier. For example, to obtain a prescription medication, the patient can obtain a prescription from the patient's doctor, provide the prescription to her pharmacy, and provide information regarding the patient's insurance policy to the pharmacy. The pharmacy can verify the insurance policy information and prescription, and dispense the medication to the patient. The pharmacy can be subsequently compensated for the transaction by submitting a reimbursement request to the patient's insurance carrier and/or receive a payment from the patient (e.g., a co-payment, a co-insurance payment, or deductible payment). Thus, the patient need only pay a portion of the cost of the medication (or nothing at all) to the pharmacy, and the remainder of the cost may be reimbursed by the insurance carrier to the pharmacy.

In some embodiments, manufacturers of prescription medications can offer promotions to encourage the sale of their products (e.g., in the form of a physical and/or electronic “coupon” or voucher). For example, a manufacturer can offer a monetary discount in connection with a particular medication, and provide information regarding the discount to doctors, pharmacies, and/or patients (e.g., information regarding the types of medication that are eligible for the promotion, the terms of the promotion, and/or the like). When the patient fulfills a prescription for the medication (e.g., by obtaining a prescription from the patient's doctor, and providing the prescription to the patient's pharmacy), the manufacturer can subsidize some or all of the patient's expenses (e.g., the patient's co-pay, co-insurance, or deductible) in obtaining the medication. For example, the manufacturer can instruct the pharmacy to reduce the patient's cost (e.g., by offsetting the amount of the co-pay, co-insurance or deductible payment), and reimburse the pharmacy for the difference in cost. Thus, the medication is provided to the customer at a discount without financial burden to the pharmacy.

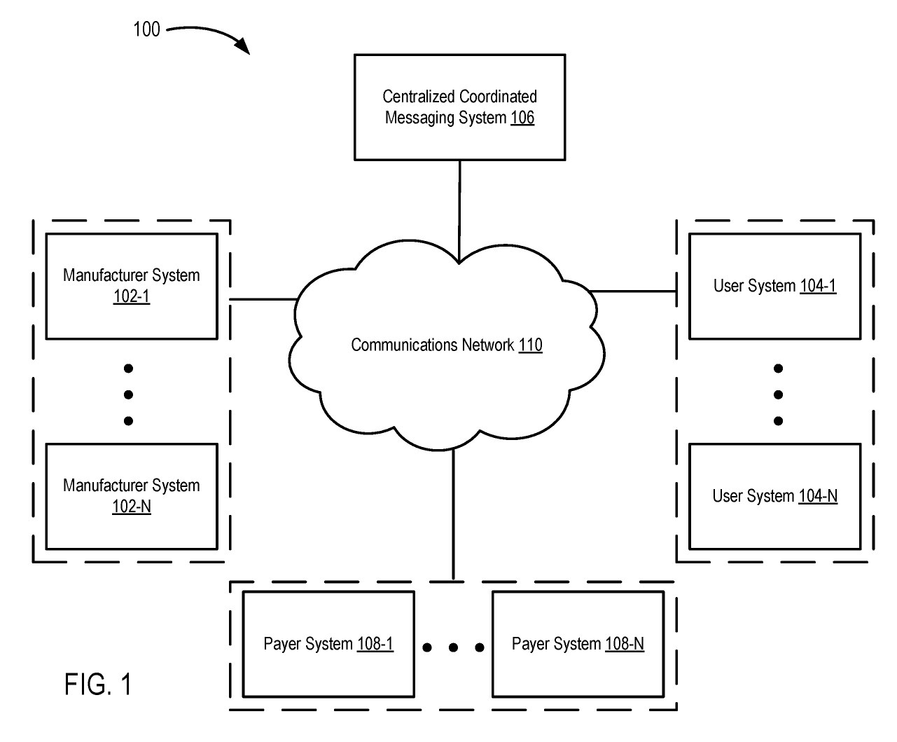

FIG. 1 depicts a diagram 100 of an example system for centralized coordinated messaging among participant nodes of a pharmaceutical network. In the example of FIG. 1, the system includes manufacturer systems 102-1 to 102-N (individually, the manufacturer system 102, collectively, the manufacturer systems 102), user systems 104-1 to 104-N (individually, the user system 104, collectively, the user systems 104), centralized coordinated messaging systems 106, payer systems 108-1 to 108-N (individually, the payer system 108, collectively, the payer systems 108), and a communication network 110.

The manufacturer systems 102 may be configured to store, generate, and/or provide promotion information (e.g., pharmaceutical promotion information). The manufacturer systems 102 may be associated with different pharmaceutical manufacturing entities. In some embodiments, functionality of the manufacturer systems 102 may be performed by one or more servers, mobile devices (e.g., smartphones, cell phones, smartwatches, tablet computers, and/or the like), desktop computers, laptop computers, workstations, and/or the like. In various embodiments, promotion information can be used to generate different types of promotions, such as co-pay promotions, co-insurance promotions, deductible promotions, and/or the like. For example, a promotion can instruct a pharmacy to reduce a patient's cost (e.g., by offsetting the amount of the co-pay, co-insurance or deductible payment), and reimburse the pharmacy for the difference in cost. Thus, the medication can be provided to the patient at a discount without financial burden to the pharmacy. In some embodiments, the manufacturer systems 102 generate and provide data messages including promotion information.

The user systems 104 may be configured to store, generate, and/or provide transaction information (e.g., pharmacy transaction information). The users systems 104 may be associated with different pharmacy entities. In some embodiments, functionality of the user systems 104 may be performed by one or more servers, mobile devices (e.g., smartphones, cell phones, smartwatches, tablet computers, and/or the like), desktop computers, laptop computers, workstations, and/or the like. For example, the user system 104 may comprise point-of-sale computing devices. Transaction information may include patient information, prescription information, payer information (e.g., insurance carrier information), and/or promotion information. In some embodiments, transaction information may be selectively provided (e.g., to reduce bandwidth requirements, throughput requirements, and/or otherwise minimize impact on network performance). In some embodiments, the user systems 104 generate and provide data messages including transaction information.

The centralized coordinated messaging system 106 may be configured to obtain, store, generate, and/or provide data messages. For example, the centralized coordinated message system 106 may obtain and/or store promotions, obtain and/or store transaction information, and/or the like. In some embodiments, functionality of the centralized coordinated messaging system 106 may be performed by one or more servers, mobile devices (e.g., smartphones, cell phones, smartwatches, tablet computers, and/or the like), desktop computers, laptop computers, workstations, and/or the like.

In some embodiments, the centralized coordinated messaging system 106 stores, generates, and/or processes promotions. In some embodiments, the centralized coordinated messaging system 106 processes promotions on behalf of pharmacies and/or manufacturers. As used herein, reference to pharmacies may refer to pharmacy entities and/or pharmacy systems (e.g., user systems 104). Similarly, reference to manufacturers may refer to manufacturer entities and/or manufacturer systems (e.g., manufacturer systems 102).

In some embodiments, the centralized coordinated messaging system 106 may receive promotion information regarding promotions offered by one or more prescription medication manufacturers (e.g., the type of medications that are eligible for discounts, the terms of each promotion, and so forth), and store, and/or otherwise maintain, the information in a datastore. The centralized coordinated messaging system 106 may generate promotions based on the promotions information. When a patient fulfills a prescription at a pharmacy, the pharmacy may provide information regarding the patient, the patient's prescription, and/or the patient's insurance policy to the centralized coordinated messaging system 106. The centralized coordinated messaging system 106 may compare the information received from the pharmacy against information stored by the centralized coordinated messaging system 106 (e.g., promotions and/or promotion information), and determine if the patient is eligible for the discount. If so, the centralized coordinated messaging system 106 may provide an authorization message to the pharmacy, authorizing the pharmacy to provide the customer a discount (e.g., by reducing the co-pay, the co-insurance, or the deductible payment by a particular percentage or amount). The centralized coordinated messaging system 106 may also provide a reimbursement request to the manufacturer, such that the pharmacy can be reimbursed for the purchase. In turn, the manufacturer can transfer funds to reimburse the transaction (e.g., either directly to the pharmacy or to the centralized coordinated messaging system 106). If the finds are transferred to the centralized coordinated messaging system 106, the centralized coordinated messaging system 106 may in turn use the funds to reimburse the pharmacy.

In some embodiments, some or all of the functions of the centralized coordinated messaging system 106 can be performed automatically (e.g., without requiring user input). For example, upon receiving patient, prescription, and/or insurance information from a user system 104, the centralized coordinated messaging system 106 can automatically determine whether the patient is eligible for a promotion. If the patient is eligible, the centralized coordinated messaging system 106 can automatically generate and provide an authorization message to the pharmacy, and automatically generate and provide a reimbursement request to the manufacturer. Thus, the patient need not manually provide the pharmacy with information regarding the terms of the promotion (e.g., by presenting a coupon or voucher), and the user does not need to manually enter in the terms of the promotion into the centralized coordinated messaging system 106. Further, the pharmacy need not manually determine whether the patient is eligible for a discount, nor manually transmit a reimbursement request to the manufacturer. Further still, the manufacturer need not manually determine whether the patient is eligible for the promotion. Thus, the promotion is provided more quickly and efficiently, and the pharmacy is reimbursed more quickly by the manufacturer.

In some embodiments, the centralized coordinated messaging systems 106 processes promotions on behalf of many different pharmacies and/or manufacturers. For example, the centralized coordinated messaging system 106 can maintain information regarding several different promotions from several different manufacturers, each with particular promotional terms. Upon receiving information from a pharmacy regarding a particular transaction, the centralized coordinated messaging system 106 may verify whether the patient is eligible for a promotion, and if so, automatically authorize the pharmacy to provide an appropriate payment to reduce to patient's costs (co-pay, co-insurance, or deductible), and may submit a reimbursement request on behalf of the pharmacy. Thus, the pharmacies can process any number of different promotions, provided by any number of different manufactures, through the centralized coordinated messaging system 106.

The payer systems 108 may be associated with one or more payers (e.g., insurance carriers) and configured to provide payment to one or more computing systems (e.g., systems 102 and/or 104). The payer systems 108 may instruct one or more financial institutions to provide physical currency (e.g., wire transfer) and/or virtual currency to the one or more computing systems.

The communications network 110 may represent one or more computer networks (e.g., LAN, WAN, or the like) or other transmission mediums. The communication network 110 can provide communication between systems 102-108 and/or other systems described herein. In some embodiments, the communication network 110 comprises one or more computing devices, routers, cables, buses, and/or other network topologies (e.g., mesh, and the like). In some embodiments, the communication network 110 may be wired and/or wireless. In various embodiments, the communication network 110 may comprise the Internet, one or more wide area networks (WANs) or local area networks (LANs), one or more networks that may be public, private, IP-based, non-IP based, and so forth.

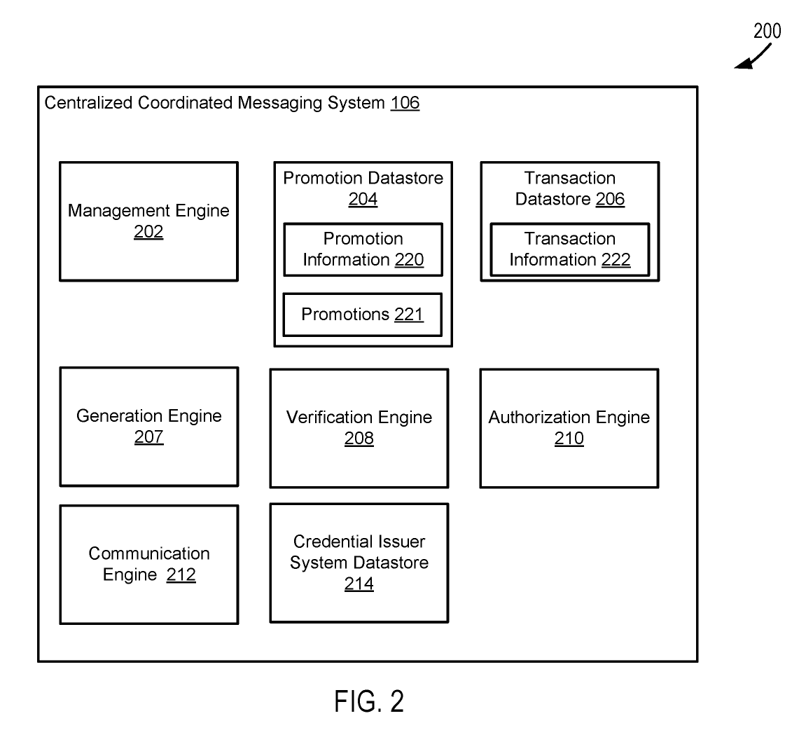

FIG. 2 depicts a diagram 200 of an example centralized coordinated messaging system 106 according to some embodiments. In the example of FIG. 2, the centralized coordinated messaging system 106 includes a management engine 202, a promotion datastore 204, a transaction datastore 206, a verification engine 208, an authorization engine 210, a communication engine 212, and a centralized coordinated messaging system datastore 214.

The management engine 202 may be configured to manage (e.g., create, read, update, delete, or otherwise access) promotion information 220 stored in the promotion datastore 204, transaction information 222 stored in the transaction datastore 206, and/or other information stored in the centralized coordinated messaging system datastore 214. The management engine 202 may perform any of these operations manually (e.g., by a user interacting with a GUI) and/or automatically (e.g., triggered by one or more of the engines 208-212, discussed below). In some embodiments, the management engine 202 comprises a library of executable instructions, which are executable by one or more processors for performing any of the aforementioned management operations.

The promotion information 220 may include a variety of data related to promotions. In some embodiments, promotion information 220 may include some or all of the following:
Promotion Information Identifier: identifies the promotion information.
Promotion Type: type of promotion (e.g., co-pay promotion, co-insurance promotion, deductible promotion).
Manufacturer Information: information of the manufacturer providing the promotion information. For example, bank identifier number (BIN), process control number (PCN), group number, and/or the like.
Promotion Eligibility Information: information used to determine eligibility for, and/or otherwise process, one or more promotions. For example, pharmaceutical identifier (e.g., medication name), dosage, promotion value (e.g., 10% discount), reimbursement rules (e.g., pharmacy offset patient cost and manufacturer reimburse pharmacy), eligible insurance carriers, eligible patients (e.g., identified by member identifiers), dates of promotion (e.g., indicating when promotion is active), and/or the like.

In some embodiments, promotion information 220 is provided by manufacturer systems and/or associated systems. In some embodiments, promotion information 220 is automatically provided by user systems. For example, a user can input information regarding a patient's prescription and/or insurance information in a user system. The user system can store pre-defined promotion information regarding the particular co-pay promotion associated with the user system (e.g., the manufacturer's promotion BIN, PCN, and/or group number) such that the user need not input this promotion information manually. In turn, the automatically provided promotion information 220 can be provided to the centralized coordinated messaging system 106 alongside patient information and/or prescription information.

In some embodiments, promotion information 220 is automatically provided by the centralized coordinated messaging system 106. For example, the centralized coordinated messaging system 106 may receive a promotion request from a user system 102 including information regarding a particular patient and prescription, but not containing any information regarding the manufacturer's promotion BIN, PCN, and group number. The centralized coordinated messaging system 106 can determine which pharmacy submitted the request (e.g., based on the network address of the associated user system 104, the login credentials used by the pharmacy to access the centralized coordinated messaging system 106, and/or the like), and automatically determine if a pharmaceutical manufacturer's promotion exists, if the patient is eligible, and determine the payment to be provided by the manufacturer to reduce the patient's expenses (e.g., co-payment, co-insurance, and/or deductible). This can be beneficial, for example, as it may reduce the amount of network traffic between the associated user system 104 and the centralized coordinated messaging system 106 (e.g., by omitting the transmission of the BIN, PCN, and/or group number for each transaction).

The promotions 221 may include a variety of data related to promotions. In some embodiments, promotions 221 may include some or all of the following:
Promotion Identifier: identifies the promotion.
Promotion Type: type of promotion (e.g., co-pay promotion, co-insurance promotion, deductible promotion).
Manufacturer Information: information of the manufacturer providing the promotion. For example, bank identifier number (BIN), process control number (PCN), group number, and/or the like.
Promotion Eligibility Information: information used to determine eligibility for, and/or otherwise process, one or more promotions. For example, pharmaceutical identifier (e.g., medication name), dosage, reimbursement rules (e.g., pharmacy offset patient cost and manufacturer reimburse pharmacy), promotion value (e.g., 10% discount), eligible insurance carriers, eligible patients (e.g., identified by member identifiers), dates of promotion (e.g., indicating when promotion is active), and/or the like.

The transaction information 222 may include a variety of data related to transactions. In some embodiments, transaction information 222 may include some or all of the following:
Transaction Identifier: identifies the transaction.
Patient Information: information of the patient associated with the transaction. For example, member identification number, insurance information, co-pay card information, and/or the like.
Prescription Information: pharmaceutical information, dosage information, and/or the like.
Pharmacy Information: identifies the pharmacy associated with the transaction.
Timestamp: date and/or time of the transaction.

The promotion generation engine 207 may be configured to generation promotions 221. For example, the promotion generation engine 207 may generation promotions 221 based on promotion information 220. The promotion generation engine 207 may generate promotions 221 in response to one or more promotion triggers. For example, promotion triggers may be based on one or more events and/or a schedule. Events may include user input (e.g., an administrator providing an instruction to generate one or more promotions), a threshold amount and/or type of corresponding promotion information (e.g., when the promotion eligibility information and corresponding prescription information is received). A schedule may include hourly, weekly, monthly, and/or other time-based schedule for generating promotions.

The verification engine 208 may be configured to verify promotions. For example, the verification engine 208 may determine whether a particular promotion is active or expired, determine which, if any, promotions are available to a patient, and/or the like. In some embodiments, the verification engine 208 is configured to determine an authenticity of transaction information, promotion information, and/or promotions. For example, the verification engine 204 may execute a CHECKSUM or other operation on received data messages to determine authenticity of transaction information, promotion information, and/or promotions, which may reduce the likelihood of falsified promotions. The verification engine 208 may be configured to determine patient eligibility for one or more promotions. For example, the verification engine 208 may compare received transaction information with one o or promotions and/or promotion information to determine whether a patient associated with the transaction information is eligible for one or more promotions.

In some embodiments, the verification engine 208 improves efficiency of the promotion verification process. For example, the terms of a manufacturer's co-payment promotion may specify that only particular medication strengths, medication dosages, medication formulation, patients, and/or types of insurance policy are eligible for a discount. Instead of requiring that the user manually input promotion information (e.g., by manually entering a BIN, a PCN, a group number associated with the promotion, and/or a member identification number identifying the patient associated with the promotion), the user may input only the information that is particular to the patient (e.g., the member identification number). In some embodiments, (e.g., for particular co-payment promotions), the member identification does not need to be entered. Information relating to the co-payment promotion offered by the pharmaceutical manufacturer (e.g., the BIN, PCN, and group number) can be automatically provided without manual intervention by the user. Thus, the centralized coordinated messaging system 106 may reduce the likelihood of data entry errors, and/or improve the speed and/or efficiency of pharmaceutical reimbursements.

The authorization engine 210 may be configured to generate invoices and/or authorize payments for eligible promotions. For example, the authorization engine 210 may generate authorization data messages indicating a particular pharmacy and/or patient to receive a promotion value associated with the eligible promotion, the payment amount, reimbursement instructions, and/or the like. In some embodiments, the authorization engine 210 calculates an amount to be charged to a patient. The authorization engine 210 may determine the amount based on co-pay information and promotion value. For example, if a promotion value is 10% and the patient's co-pay is $100, the amount to be charged may be $90, and the manufacturer may be instructed to pay the pharmacy $10.

The authorization engine 210 may be configured to generate invoices and/or authorize payments in response to authorization triggers. For example, authorization triggers may be based on one or more events and/or a schedule. Events may include user input (e.g., an administrator providing an instruction to generate one or more invoices), and/or a threshold amount of processed promotions (e.g., when a threshold amount of promotions have been processed for a particular manufacturer entity). A schedule may include hourly, weekly, monthly, and/or other time-based schedule for generating invoices and/or authorizing payments.

The communication engine 212 may be configured send requests, transmit and receive communications, and/or otherwise provide communication with one or a plurality of systems. In some embodiments, the communication engine 212 functions to encrypt and decrypt communications. The communication engine 212 may function to send requests to and receive data from a system through a network or a portion of a network. Depending upon implementation-specific or other considerations, the communication engine 212 may send requests and receive data through a connection, all or a portion of which may be a wireless connection. The communication engine 212 may request and receive messages, and/or other communications from associated systems.

The centralized coordinated messaging system datastore 214 may be configured to store, at least temporarily, data received from one or more other systems. For example, the centralized coordinated messaging system datastore 214 may store messages received by the communication engine 212. Like other datastores described herein, the centralized coordinated messaging system datastore 214 may reside local to the centralized coordinated messaging system datastore 214, or comprise an associated remote storage system (e.g., a cloud storage system).

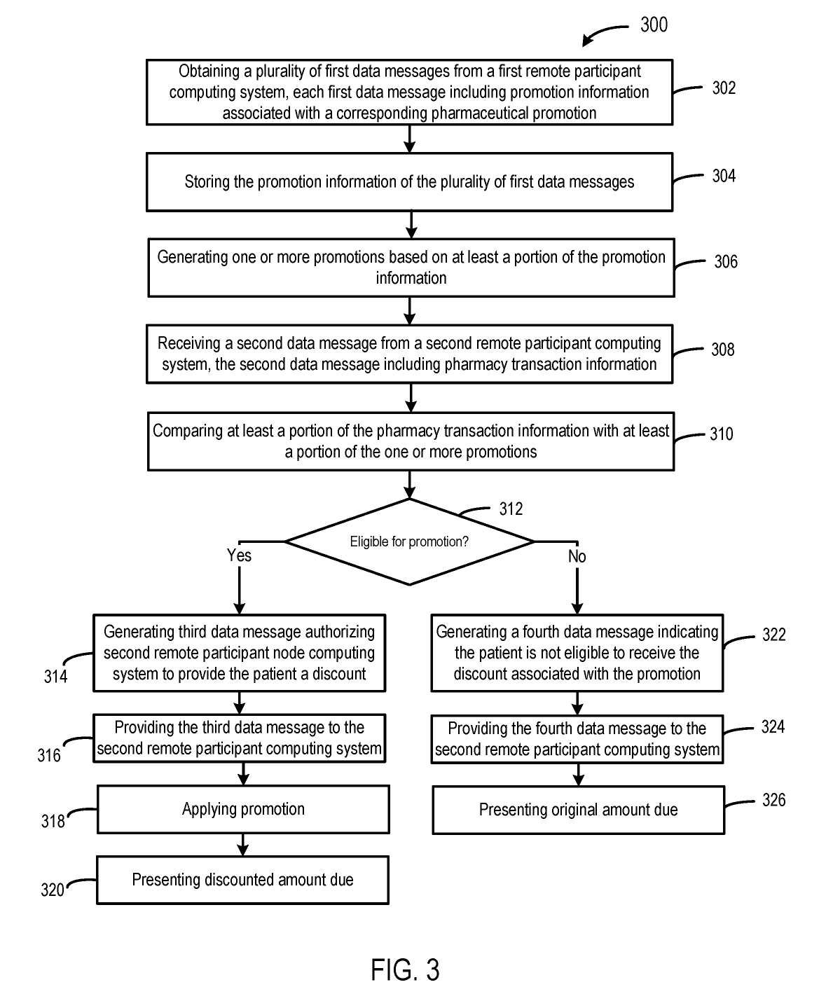

FIG. 3 depicts a flowchart 300 of an example method of centrally coordinating messages among participant nodes of a pharmaceutical network according to some embodiments. In this and other flowcharts, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 302, a central participant node computing system (e.g., centralized coordinated messaging system 106) obtains a plurality of first data messages, each of the plurality of first data messages including promotion information (e.g., promotion information 220), the plurality of first data messages being received over a communication network (e.g., communication network 110) from a plurality of first remote participant node computing systems (e.g., manufacturer systems 102). In some embodiments, a verification engine (e.g., verification engine 208) and/or a communication engine (e.g., communication engine 212) obtain the data messages.

In step 304, the central participant node computing system stores the promotion information of the plurality of first data messages in a datastore (e.g., a promotion datastore 204) of the central participant node computing system. In some embodiments, a management engine (e.g., management engine 202) stores the promotion information and/or data messages.

In step 304, the central participant node computing system generates one or more promotions (e.g., promotions 221) based on at least a portion of the promotion information. In some embodiments, a generation engine (e.g., generation engine 202) generates the one or more promotions.

In step 308, the central participant node computing system receives a second data message including pharmacy transaction information (e.g., transaction information 222), the pharmacy transaction information including patient information and prescription information associated with a particular pharmacy transaction, the second data message being received over the communication network from a second remote participant node computing system (e.g., a user system 104). In some embodiments, the communication engine receives the second data message.

In step 310, the central participant node computing system compares the pharmacy transaction information with at least a portion of the one or more promotions. In some embodiments, the verification engine performs the comparison.

In step 312, the central participant node computing system determines whether a patient associated with the pharmacy transaction information is eligible for at least one of the one or more promotions based on the comparing. In some embodiments, the verification engine determines eligibility.

In step 314, the central participant node computing system, if the patient associated with the pharmacy transaction information is eligible for at least one of the one or more promotions, generates a third data message authorizing the second remote participant node computing system to provide the patient a discount based on the at least one of the one or more promotions. In some embodiments, an authorization engine (e.g., authorization engine 210) generates the data message.

In step 316, the central participant node computing system provides the third data message to the second remote participant node computing system over the communication network. In some embodiments, the communication engine provides the data message over the communication network.

In step 318, the central participant node computing system applies the at least one promotion. For example, the central participant node computing system may determine a discounted amount to be charged to the patient based on a promotion value associated with the promotion. In some embodiments, the authorization engine determines the discounted amount. In other embodiments, the second remote participant computing system applies the pharmaceutical promotion.

In step 320, the second remote participant computing system presents the discounted amount to be charged. For example, the central participant node computing system may transmit the discounted amount to the second remote participant computing system over the communication network, and the second remote participant computing system may display the amount to be charged.

In step 322, the central participant node computing system, if the patient associated with the pharmacy transaction information is not eligible for at least one of the one or more promotions, generates a fourth data message indicating the patient is not eligible to receive the discount associated with the promotion. In some embodiments, the authorization engine generates the data message. In step 324, the central participant node computing system provides the fourth data message to the second remote participant computing system. In some embodiments, the communication provides the fourth data message of the communication network.

In step 326, the second remote participant computing system presents the original amount (e.g., the undiscounted co-pay amount) to be charged. For example, the central participant node computing system may transmit the discounted amount to the second remote participant computing system, and the second remote participant computing system may display the amount. In some embodiments, the communication engine transmits the original amount to be charged over the communication network.

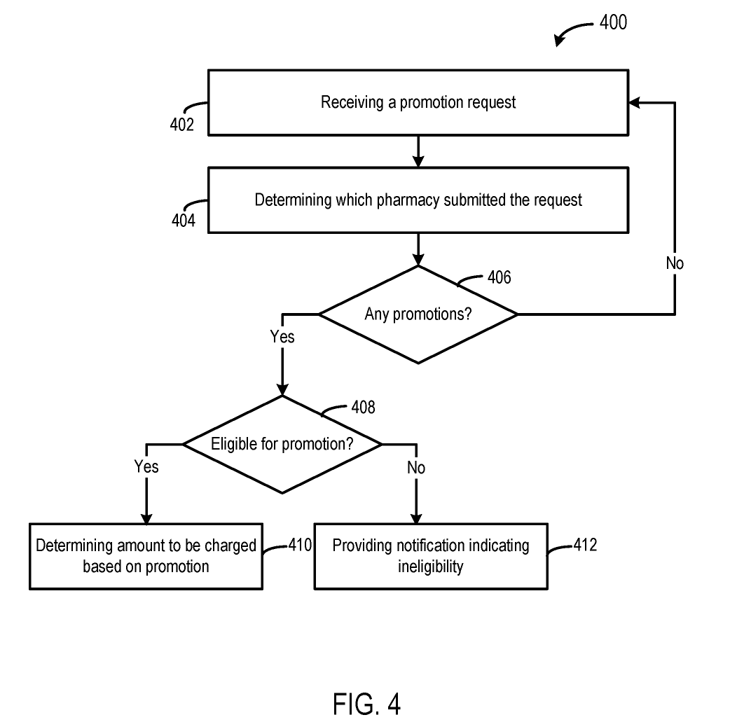

FIG. 4 depicts a flowchart 400 of an example method of reducing network performance load based on central coordination of messages among participant nodes of a pharmaceutical network according to some embodiments.

In step 402, a central participant node computing system (e.g., centralized coordinated messaging system 106) receives a promotion request. The promotion request may comprise at least a portion of transaction information (e.g., transaction information 222) and/or promotion information (e.g., promotion information 220). The promotion request may be received from a second participant node computing system (e.g., user system 104). In some embodiments, the promotion request includes patient information and prescription information, but does not include information regarding some or all promotion information. In some embodiments, a verification engine (e.g., verification engine 208) and/or communication engine (e.g., communication engine 212) receives the promotion request over a communication network (e.g., communication network 110).

In step 404, the central participant node computing system determines which second remote participant node computing system and/or associated pharmacy entity submitted the request. For example, the central participant node computing system may determine which second remote participant node computing system and/or associated pharmacy entity submitted the request based on the network address of the second remote participant node computing system, login credentials used by a user and/or second remote participant node computing system to access the central participant node computing system, and/or the like. In some embodiments, the verification engine determines which second remote participant node computing system and/or associated pharmacy submitted the request.

In step 406, the central participant node computing system determines whether any promotions are associated with the promotion request. In some embodiments, the verification engine determines whether any promotions are associated with the promotion request.

In step 408, if there are any promotions associated with the promotion request, the central participant node computing system determines whether a patient associated with the request is eligible for the promotion. In some embodiments, the verification engine determines whether the patient is eligible for the promotion.

In step 410, if the patient is eligible for a promotion, the central participant node computing system determines an amount to be charged based on the promotion request. In some embodiments, an authorization engine (e.g., authorization engine 210) determines the amount to be charged.

In step 412, if the patient is eligible for a promotion, the central participant node computing system provides a notification indicating the patient is not eligible for the promotion. In some embodiments, the authorization engine and/or communication engine provide the notification to the second remote participant node computing system over the communication network.

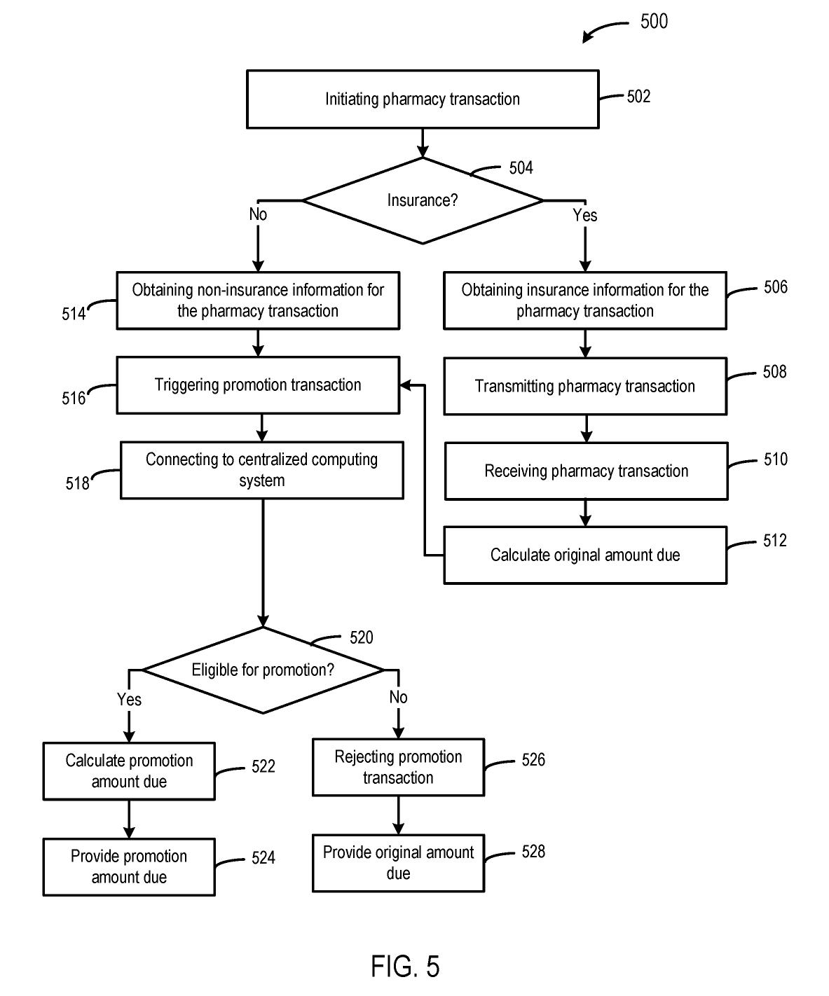

FIG. 5 depicts a flowchart 500 of an example method of centrally coordinating messages among participant nodes of a pharmaceutical network according to some embodiments.

In step 502, a second remote participant computing system (e.g., user system 104) initiates a pharmacy transaction. In step 504, the second remote participant computing system determines whether a patient associated with the pharmacy transaction has insurance. In step 506, if the patient has insurance, the second remote participant computing system obtains the insurance information for the pharmacy transaction. In step 508, the second remote participant computing system provides the pharmacy transaction and/or insurance information to a payer system (e.g., payer system 108). In some embodiments, the pharmacy transaction and/or insurance information is provided over a communication network (e.g., communication network 110).

In step 510, the payer system receives the pharmacy transaction and/or insurance information. In some embodiments, the payer system receives the pharmacy transaction and/or insurance information over the communication network. In step 512, the payer system calculates an original amount due. For example, the payer system may calculate the original amount due based on insurance co-pay information.

In step 514, if the patient does not have insurance, the second remote participant computing system obtains non-insurance information (e.g., co-pay card information). In step 516, the second remote participant computing system triggers a promotion transaction (e.g., a promotion request). For example, the second remote participant computing system may trigger a promotion transaction in response to receiving input from a user, obtaining non-insurance information, and/or calculation of an original amount to be charged.

In step 518, the second remote participant computing system connects to a central participant node computing system (e.g., centralized coordinated messaging system 106). In some embodiments, the second remote participant computing system connects to a central participant node computing system over the communication network.

In step 520, the central participant node computing system determines whether a promotion is available and if a patient associated with the promotion transactions is eligible for the promotion. In some embodiments, a verification engine (e.g., verification engine 208) performs the determination.

In step 522, the central participant node computing system, if there is a promotion available and the patient is eligible for the promotion, calculates an amount to be charged. For example, the amount to be charged can be based on the original amount and a promotion value of the available promotion. In some embodiments, an authorization engine (e.g., authorization engine 210) performs the calculation.

In step 524, the central participant node computing system provides the amount to the second remote participant computing system. The second remote participant computing system may display the amount. In some embodiments, a communication engine (e.g., communication engine 212) provides the amount to the second remote participant computing system over the communication network.

In step 526, the central participant node computing system, if a promotion is not available or the patient is ineligible for an available promotion, rejects the promotion transaction. In some embodiments, the authorization engine rejects the promotion transaction.

In step 528, the central participant node computing system provides the original amount the second remote participant computing system. The second remote participant computing system may display the original amount. In some embodiments, the communication provides the original amount the second remote participant computing system over the communication network.

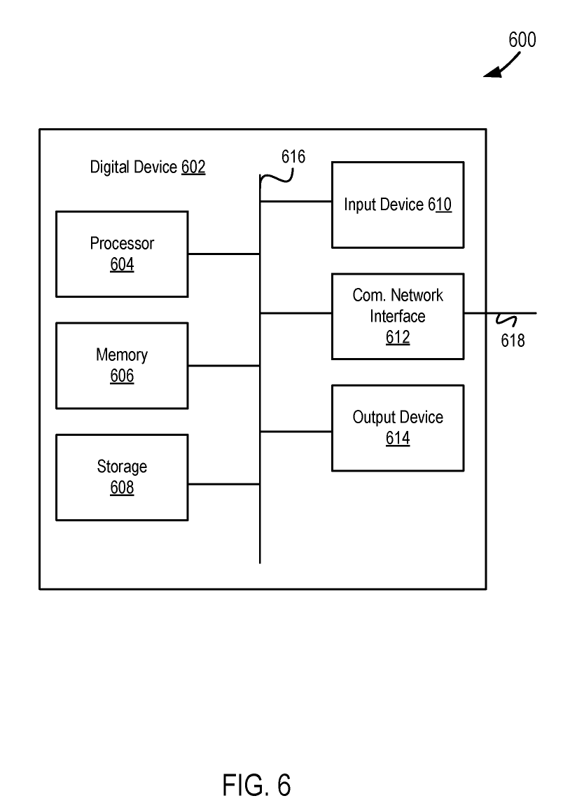

FIG. 6 depicts a diagram 600 of an example of a computing device 602. Any of the manufacturer systems 102, the user systems 104, the centralized coordinated messaging system 106, the payer systems 108, and the communication network 110 may comprise an instance of one or more computing devices 602. The computing device 602 comprises a processor 604, memory 606, storage 608, an input device 610, a communication network interface 612, and an output device 614 communicatively coupled to a communication channel 616. The processor 604 is configured to execute executable instructions (e.g., programs). In some embodiments, the processor 604 comprises circuitry or any processor capable of processing the executable instructions.

The memory 606 stores data. Some examples of memory 606 include storage devices, such as RAM, ROM, RAM cache, virtual memory, etc. In various embodiments, working data is stored within the memory 606. The data within the memory 606 may be cleared or ultimately transferred to the storage 608.

The storage 608 includes any storage configured to retrieve and store data. Some examples of the storage 608 include flash drives, hard drives, optical drives, cloud storage, and/or magnetic tape. Each of the memory system 606 and the storage system 608 comprises a computer-readable medium, which stores instructions or programs executable by processor 604.

The input device 610 is any device that inputs data (e.g., mouse and keyboard). The output device 614 outputs data (e.g., a speaker or display). It will be appreciated that the storage 608, input device 610, and output device 614 may be optional. For example, the routers/switchers may comprise the processor 604 and memory 606 as well as a device to receive and output data (e.g., the communication network interface 612 and/or the output device 614).

The communication network interface 612 may be coupled to a network (e.g., network 110) via the link 618. The communication network interface 612 may support communication over an Ethernet connection, a serial connection, a parallel connection, and/or an ATA connection. The communication network interface 612 may also support wireless communication (e.g., 802.11 a/b/g/n, WiMax, LTE, WiFi). It will be apparent that the communication network interface 612 may support many wired and wireless standards.

It will be appreciated that the hardware elements of the computing device 602 are not limited to those depicted in FIG. 6. A computing device 602 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 604 and/or a co-processor located on a GPU (i.e., NVidia).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. It will be appreciated that any of the systems described herein may comprise existing systems (e.g., controlled by one or more third-parties) and/or comprise systems controlled by one or more centralized systems (e.g., a central server system).

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A method comprising:
obtaining, by a central participant node computing system, a plurality of first data messages, each of the plurality of first data messages including promotion information, the plurality of first data messages being received over a communication network from a plurality of first remote participant node computing systems;
storing, by the central participant node computing system, the promotion information of the plurality of first data messages in a datastore of the central participant node computing system;
generating, by the central participant node computing system, one or more promotions based on the promotion information;
receiving, by the central participant node computing system, a second data message including pharmacy transaction information, the pharmacy transaction information including patient information and prescription information associated with a particular pharmacy transaction, the second data message being received over the communication network from a second remote participant node computing system;
comparing, by the central participant node computing system, the pharmacy transaction information with at least a portion of the one or more promotions;
determining, by the central participant node computing system, whether a patient associated with the pharmacy transaction information is eligible for at least one of the one or more promotions based on the comparing;
if the patient associated with the pharmacy transaction information is eligible for at least one of the one or more promotions:
generating, by the central participant node computing system, a third data message, the third data message authorizing the second remote participant node computing system to provide the patient a discount based on the at least one promotion; and
providing, by the central participant node computing system, the third data message to the second remote participant node computing system over the communication network;
if the patient associated with the pharmacy transaction information is not eligible for at least one of the one or more promotions:
generating, by the central participant node computing system, a fourth data message, the fourth data message indicating the patient is not eligible to receive a discount; and
providing, by the central participant node computing system, the fourth data message to the second remote participant node computing system over the communication network.

2. The method of claim 1, wherein the promotion information includes any of corresponding manufacturer identification information associated with each of the corresponding promotions, a type of promotion associated with each of the corresponding promotions, or a promotion value associated with each of the corresponding promotions.

3. The method of claim 1, wherein in the first remote participant node computing system comprises a pharmaceutical manufacturing system remote from the central participant node computing system.

4. The method of claim 1, wherein the patient information includes any of a member identifier identifying the patient, or insurance information associated with the patient, and the prescription information includes a pharmaceutical identifier and a pharmaceutical dosage amount.

5. The method of claim 1, wherein the pharmacy transaction information includes manufacturer information associated with a particular promotion, and the comparing and the determining are performed utilizing the manufacturer information of the pharmacy transaction information.

6. The method of claim 5, wherein the manufacturer information of the pharmacy transaction comprises pre-defined manufacturer information obtained from a second datastore of the second remote participant node computing system.

7. The method of claim 1, wherein the pharmacy transaction information does not include manufacturer information, and the comparing and the determining are performed utilizing manufacturer information stored by the central participant node computing system, thereby reducing a performance load of the communication network.

8. The method of claim 1, further comprising determining, by the central participant node computing system, the discount in response to a determination the patient is eligible for at least one of the one or more promotions.

9. The method of claim 1, wherein the discount is determined by a payer system in remote communication with the central participant node computing system over the communication network.

10. A central participant node computing system comprising:
one or more processors; and
memory storing instructions that, when executed by the one or more processors, cause the central participant node computing system to perform:
obtaining a plurality of first data messages, each of the plurality of first data messages including promotion information, the plurality of first data messages being received over a communication network from a plurality of first remote participant node computing systems;
storing the promotion information of the plurality of first data messages in a datastore of the central participant node computing system;
generating one or more promotions based on the promotion information;
receiving a second data message including pharmacy transaction information, the pharmacy transaction information including patient information and prescription information associated with a particular pharmacy transaction, the second data message being received over the communication network from a second remote participant node computing system;
comparing the pharmacy transaction information with at least a portion of the one or more promotions;
determining, by the central participant node computing system, whether a patient associated with the pharmacy transaction information is eligible for at least one of the one or more promotions based on the comparing;
if the patient associated with the pharmacy transaction information is eligible for at least one of the one or more promotions:
generating a third data message, the third data message authorizing the second remote participant node computing system to provide the patient a discount based on the at least one promotion; and
providing the third data message to the second remote participant node computing system over the communication network;
if the patient associated with the pharmacy transaction information is not eligible for at least one of the one or more promotions:
generating a fourth data message, the fourth data message indicating the patient is not eligible to receive a discount; and
providing the fourth data message to the second remote participant node computing system over the communication network.

11. The central participant node computing system of claim 10, wherein the promotion information includes any of corresponding manufacturer identification information associated with each of the corresponding promotions, a type of promotion associated with each of the corresponding promotions, or a promotion value associated with each of the corresponding promotions.

12. The central participant node computing system of claim 10, wherein in the first remote participant node computing system comprises a pharmaceutical manufacturing system remote from the central participant node computing system.

13. The central participant node computing system of claim 10, wherein the patient information includes any of a member identifier identifying the patient, or insurance information associated with the patient, and the prescription information includes a pharmaceutical identifier and a pharmaceutical dosage amount.

14. The central participant node computing system of claim 10, wherein the pharmacy transaction information includes manufacturer information associated with a particular promotion, and the comparing and the determining are performed utilizing the manufacturer information of the pharmacy transaction information.

15. The central participant node computing system of claim 14, wherein the manufacturer information of the pharmacy transaction comprises pre-defined manufacturer information obtained from a second datastore of the second remote participant node computing system.

16. The central participant node computing system of claim 10, wherein the pharmacy transaction information does not include manufacturer information, and the comparing and the determining are performed utilizing manufacturer information stored by the central participant node computing system, thereby reducing a performance load of the communication network.

17. The central participant node computing system of claim 10, further comprising determining, by the central participant node computing system, the discount in response to a determination the patient is eligible for the at least one of the one or more promotions.

18. The central participant node computing system of claim 10, wherein the discount is determined by a payer system in remote communication with the central participant node computing system over the communication network.

19. A non-transitory computer readable medium comprising instructions that, when executed, cause one or more processors to perform:
obtaining, by a central participant node computing system, a plurality of first data messages, each of the plurality of first data messages including promotion information, the plurality of first data messages being received over a communication network from a plurality of first remote participant node computing systems;
storing, by the central participant node computing system, the promotion information of the plurality of first data messages in a datastore of the central participant node computing system;
generating, by the central participant node computing system, one or more promotions based on the promotion information;
receiving, by the central participant node computing system, a second data message including pharmacy transaction information, the pharmacy transaction information including patient information and prescription information associated with a particular pharmacy transaction, the second data message being received over the communication network from a second remote participant node computing system;
comparing, by the central participant node computing system, the pharmacy transaction information with at least a portion of the one or more promotions;
determining, by the central participant node computing system, whether a patient associated with the pharmacy transaction information is eligible for at least one of the one or more promotions based on the comparing;
if the patient associated with the pharmacy transaction information is eligible for at least one of the one or more promotions:
generating, by the central participant node computing system, a third data message, the third data message authorizing the second remote participant node computing system to provide the patient a discount based on the at least one promotion; and
providing, by the central participant node computing system, the third data message to the second remote participant node computing system over the communication network;
if the patient associated with the pharmacy transaction information is not eligible for at least one of the one or more promotions:
generating, by the central participant node computing system, a fourth data message, the fourth data message indicating the patient is not eligible to receive a discount; and
providing, by the central participant node computing system, the fourth data message to the second remote participant node computing system over the communication network.

20. A method comprising:
obtaining, by a central participant node computing system, a first data message including promotion information associated with one or more pharmaceutical promotions, the first data message being received over a communication network from a first remote participant node computing system;
storing, by the central participant node computing system, the promotion information in a datastore of the central participant node computing system;
receiving, by the central participant node computing system, a second data message including pharmacy transaction information, the pharmacy transaction information including patient information associated with a particular pharmacy transaction, the second data message being received over the communication network from a second remote participant node computing system;
comparing, by the central participant node computing system, the pharmacy transaction information with the promotion information;
determining, by the central participant node computing system, whether a patient associated with the pharmacy transaction information is eligible for one or more pharmaceutical promotions associated with the promotion information based on the comparing;
if the patient associated with the pharmacy transaction information is eligible for one or more pharmaceutical promotions associated with the promotion information:
generating, by the central participant node computing system, a third data message, the third data message authorizing the second remote participant node computing system to provide the patient a discount based on the promotion information; and
providing, by the central participant node computing system, the third data message to the second remote participant node computing system over the communication network;
if the patient associated with the pharmacy transaction information is not eligible for one or more pharmaceutical promotions associated with the promotion information:
generating, by the central participant node computing system, a fourth data message, the fourth data message indicating the patient is not eligible to receive a discount; and
providing, by the central participant node computing system, the fourth data message to the second remote participant node computing system over the communication network.
